(19) United States
(12) Patent Application Publication
(10) Pub. No.: US 2024/0160196 A1
(43) Pub. Date: May 16, 2024

(54) HYBRID MODEL CREATION METHOD, HYBRID MODEL CREATION DEVICE, AND RECORDING MEDIUM

(71) Applicant: Panasonic Intellectual Property Management Co., Ltd., Osaka (JP)

(72) Inventors: Yao ZHOU, Singapore (SG); Athul M. MATHEW, Singapore (SG); Ariel BECK, Singapore (SG); Chandra Suwandi WIJAYA, Singapore (SG); Nway Nway AUNG, Singapore (SG); Khai Jun KEK, Singapore (SG); Yuya SUGASAWA, Osaka (JP); Jeffry FERNANDO, Osaka (JP); Yoshinori SATOU, Osaka (JP); Hisaji MURATA, Osaka (JP)

(21) Appl. No.: 18/283,411

(22) PCT Filed: Mar. 25, 2022
(86) PCT No.: PCT/JP2022/014692

§ 371 Date: Sep. 21, 2023

Related U.S. Application Data
(60) Provisional application No. 63/171,016, filed on Apr. 5, 2021.

(51) Int. Cl. G05B 19/418; G05B 13/02

(52) U.S. Cl. CPC G05B 19/41875; G05B 13/0265; G05B 2219/32368

(57) ABSTRACT

First, a plurality of models that predict categories of input data are pooled. At least one of the plurality of models is a model trained by machine learning. Next, each of a plurality of hybrid model candidates that judge the categories are created by selecting and combining two or more models from among the plurality of pooled models. Then, by comparing the plurality of hybrid model candidates, one of the plurality of hybrid model candidates is selected as a hybrid model.

### CROSS-REFERENCE OF RELATED APPLICATIONS

This application is the U.S. National Phase under 35 U.S.C. § 371 of International Patent Application No. PCT/JP2022/014692, filed on Mar. 25, 2022, which in turn claims the benefit of U.S. Provisional Patent Application No. 63/171,016, filed on Apr. 5, 2021, the entire disclosures of which applications are incorporated by reference herein.

### TECHNICAL FIELD

The present disclosure relates to a hybrid model creation method, a hybrid model creation device, and a recording medium.

### BACKGROUND ART

Visual inspection systems using AI technology are becoming more common. Since different AI models have different advantages and disadvantages, techniques for increasing accuracy by combining a plurality of AI models to obtain the complementary advantages of each have been proposed (see, for example, Patent Literature (PTL) 1). PTL 1 discloses obtaining a final judgment by integrating the results obtained using all of the plurality of models included in the device.

### CITATION LIST

### Patent Literature

[PTL 1] WO 2018/079840

### SUMMARY OF INVENTION

### Technical Problem

Unfortunately, with the technique disclosed in PTL 1, since all of the models included in the device are used, redundant models that are not complementary to other models are combined and used.

The present disclosure was conceived in view of the above, and has an object to provide a hybrid model creation method, etc., that can create a more accurate hybrid model.

### Solution to Problem

In order to achieve the above object, a hybrid model creation method according to one aspect of the present disclosure includes: pooling a plurality of models that predict categories of input data, at least one of the plurality of models being a model trained by machine learning; creating each of a plurality of hybrid model candidates that judge the categories, by selecting and combining two or more models from among the plurality of models pooled; and selecting one of the plurality of hybrid model candidates as a hybrid model by comparing the plurality of hybrid model candidates.

With this, a plurality of models can be used to create a more accurate hybrid model.

General or specific aspects of the present disclosure may be realized as a device, a method, an integrated circuit, a computer program, a computer readable recording medium such as a CD-ROM, or any given combination thereof.

### Advantageous Effects of Invention

According to the present disclosure, it is possible to provide a hybrid model creation method, etc., that can create a more accurate hybrid model using a plurality of models.

### BRIEF DESCRIPTION OF DRAWINGS

FIG. 1 is a block diagram illustrating the functional configuration of a hybrid model creation device according to an embodiment of the present disclosure.

FIG. 2 is for conceptually illustrating processes performed when a hybrid model creation method according to an embodiment of the present disclosure is executed.

FIG. 3 is a flowchart illustrating an overview of operations performed by a hybrid model creation device according to an embodiment of the present disclosure.

FIG. 4 is a flowchart illustrating one example of the detailed processing of step S1 in Implementation Example 1.

FIG. 5 is a flowchart illustrating one example of the detailed processing of step S1 in Implementation Example 2.

FIG. 6 is a flowchart illustrating one example of the detailed processing of step S3 in Implementation Example 3.

FIG. 7A is for illustrating the accuracy of a hybrid model candidate when three strongly correlated models are combined in Implementation Example 3.

FIG. 7B is for illustrating the accuracy of a hybrid model candidate when three weakly correlated models are combined in Implementation Example 3.

FIG. 8 is for conceptually illustrating of one example of the specifics of a hybrid model candidate creation process in Implementation Example 4.

FIG. 9 is a flowchart illustrating one example of processes performed by a hybrid model creation device according to Implementation Example 4.

FIG. 10 is a flowchart illustrating one example of the detailed processing of step S3 in Implementation Example 5.

FIG. 11 conceptually illustrates one example of a hybrid model candidate created by combining model 1 and model 2 in Implementation Example 6.

FIG. 12 is a flowchart illustrating one example of the detailed processing of step S3 in Implementation Example 6.

FIG. 13 conceptually illustrates outputs of model 1 and model 2 as well as a convex envelope of the distribution of outputs corresponding to defective images according to Implementation Example 7.

FIG. 14 conceptually illustrates one example of a hybrid model candidate created from the outputs of model 1 and model 2, excluding each output corresponding to a defective image except the vertices of the convex envelope illustrated in FIG. 13.

FIG. 15 is a flowchart illustrating one example of the detailed processing of step S3 in Implementation Example 7.

FIG. 16 conceptually illustrates the outputs of model 1 and model 2 and an exclusion region according to Implementation Example 7.

FIG. 17 conceptually illustrates one example of a hybrid model candidate created from the outputs of model 1 and model 2, excluding each output corresponding to a defective image except that is included in the exclusion region illustrated in FIG. 16.

FIG. 18 illustrates a method of calculating a FAR curve for model 1 according to Implementation Example 8.

FIG. 19 illustrates one example of a FAR table for model 1 according to Implementation Example 8.

FIG. 20 conceptually illustrates first FAR values of each of two models and second FAR values of a hybrid model candidate created by combining the two models according to Implementation Example 8.

FIG. 21 illustrates one example of a hybrid model creation method according to another embodiment.

FIG. 22 illustrates another example of a hybrid model creation method according to another embodiment.

FIG. 23A illustrates one example of a confusion matrix table according to another embodiment.

FIG. 23B illustrates one example of a confusion matrix table according to another embodiment.

### DESCRIPTION OF EMBODIMENTS

Hereinafter, embodiments of the present disclosure will be described in detail with reference to the drawings. Each embodiment described below shows a specific example of the present disclosure. The numerical values, shapes, materials, standards, elements, the arrangement and connection of the elements, steps, order of the steps etc., indicated in the following embodiments are mere examples, and therefore do not intend to limit the present disclosure. Therefore, among elements in the following embodiments, those not recited in any of the independent claims of the present disclosure are described as optional elements. The figures are not necessarily precise illustrations. In the figures, elements that are essentially the same share like reference signs, and repeated description thereof may be omitted or simplified.

### Embodiment

First, an overview of the hybrid model creation device and the hybrid model creation method according to the present embodiment will be described.

### [1. Overview of Hybrid Model Creation Device 10]

Hereinafter, an overview of the configuration and the like of hybrid model creation device 10 according to the present embodiment will be described.

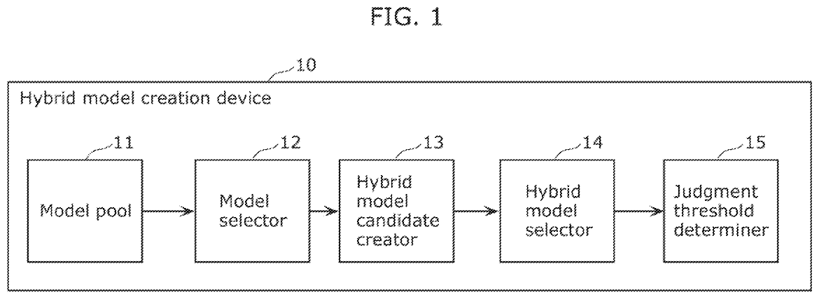

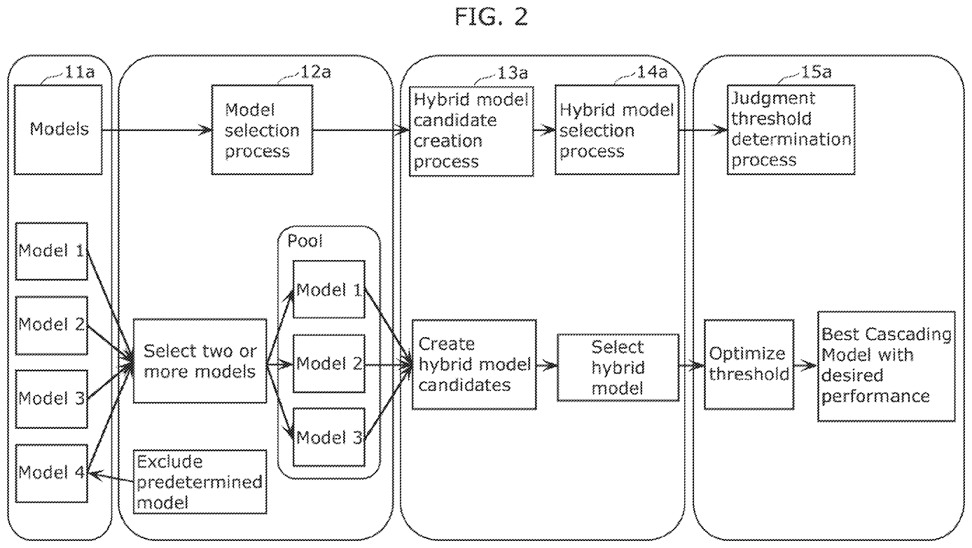

FIG. 1 is a block diagram illustrating the functional configuration of hybrid model creation device 10 according to the present embodiment. FIG. 2 is for conceptually illustrating processes performed when the hybrid model creation method according to the present embodiment is executed.

Hybrid model creation device 10 is realized by, for example, a computer, and can create a more accurate hybrid model using a plurality of models.

In the present embodiment, as illustrated in FIG. 1, hybrid model creation device 10 includes model pool 11, model selector 12, hybrid model candidate creator 13, hybrid model selector 14, and judgment threshold determiner 15. Note that judgment threshold determiner 15 may be included in a different device than hybrid model creation device 10.

### [1-1. Model Pool 11]

Model pool 11 includes a hard disk drive (HDD) or memory, etc., and pools (stores) a plurality of models that predict the categories of input data. In the present embodiment, model pool 11 pools a plurality of models 11a that have been created in advance, such as model 1, model 2, model 3, and model 4, as illustrated in FIG. 2. Here, at least one of the plurality of models 11a is a model trained by machine learning. Each of the plurality of models 11a can also be referred to as an AI model. In the present embodiment, the input data is assumed to be an inspection image of a manufactured product. At least one of the plurality of models 11a is an AI model trained by deep learning. The plurality of models 11a may include an AI model with manually designed features. For example, each of the plurality of models 11a takes an inspection image of a manufactured product as input, and predicts and outputs the probability that the manufactured product in the inspection image is defective. Each of the plurality of models 11a may output a binary prediction of whether the manufactured product in the inspection image is defective or not.

### [1-2. Model Selector 12]

Model selector 12 selects two or more models from the plurality of models pooled in model pool 11. In the present embodiment, model selector 12 selects two or more models from the plurality of models pooled in model pool 11, after excluding a predetermined model from the plurality of models. In the example illustrated in FIG. 2, model selector 12 performs model selection process 12a of selecting two or more models from model 1, model 2, model 3, and model 4, after excluding model 4 as a predetermined model. Model selector 12 may select two or more models after excluding a predetermined model from the plurality of models pooled by model pool 11, and may select two or more models having excluded a predetermined model, from among the plurality of models pooled by model pool 11. The predetermined model may be, for example, a model with low prediction accuracy or a model having a strong correlation with another model. Specifics of how such a predetermined model is excluded will be described later in Implementation Examples 1 and 2, so detailed description here is omitted.

### [1-3. Hybrid Model Candidate Creator 13]

Hybrid model candidate creator 13 combines two or more models selected by model selector 12 to create a plurality of hybrid model candidates that judge the categories. Hybrid model candidate creator 13 may create a plurality of hybrid model candidates by combining two or more models selected by model selector 12 so as not to include a combination of models having a stronger correlation than a threshold. The hybrid model candidates may be created by simply concatenating (cascading) two or more models selected by model selector 12, or by combining two or more models selected by model selector 12 using, for example, logistic regression, which will be described later.

In the example illustrated in FIG. 2, hybrid model candidate creator 13 performs hybrid model candidate creation process 13a of creating hybrid model candidates by combining model 1, model 2, and model 3 selected by model selector 12. More specifically, hybrid model candidate creator 13 creates hybrid model candidate 1, which combines model 1 and model 2, for example, and hybrid model candidate 2, which combines model 2 and model 3, for example. Hybrid model candidate creator 13 also creates hybrid model candidate 3, which combines model 1 and model 3, for example, and hybrid model candidate 4, which combines model 1, model 2, and model 3, for example. In the present embodiment, the categories include a category in which the manufactured product in the inspection image is non-defective and a category in which the manufactured product in the inspection image is defective. Stated differently, hybrid model candidate 3 judges whether the manufactured product in the inspection image is non-defective or defective. Note that hybrid model candidates 1 through 3 may output a judgment produced by probabilistically judging (predicting) whether the manufactured product in the inspection image is defective.

Specifics of how the hybrid model candidates are created will be described later in Implementation Examples 3 through 6, so detailed description here is omitted.

Hybrid model candidate creator 13 also compares the created hybrid model candidates.

In the example illustrated in FIG. 2, hybrid model candidate creator 13 performs a comparison process of comparing the created hybrid model candidates 1 through 4. Methods of comparing hybrid model candidates 1 through 4 include, for example, comparing the accuracies of the judgments of hybrid model candidates 1 through 4, and comparing the importance (also called contribution) of each of the two or more constituent models, which can be calculated from the judgments of hybrid model candidates 1 through 4.

Specifics of how the hybrid model candidates are compared will be described later in, for example, Implementation Example 2, so detailed description here is omitted.

### [1-4. Hybrid Model Selector 14]

Hybrid model selector 14 selects one of the plurality of hybrid model candidates as a hybrid model based on the comparison results of the plurality of hybrid model candidates.

In the example illustrated in FIG. 2, hybrid model selector 14 performs hybrid model selection process 14a of selecting one of hybrid model candidates 1 through 4 as the hybrid model based on the comparison results of hybrid model candidates 1 through 4.

In hybrid model selection process 14a, based on the comparison results of hybrid model candidates 1 through 4, the hybrid model candidate consisting of the combination of models with the highest judgment accuracy or highest importance is selected as the hybrid model.

Specifics of how the hybrid model is selected will be described later, so detailed description here is omitted.

### [1-5. Judgment Threshold Determiner 15]

Judgment threshold determiner 15 adjusts the sensitivity of the hybrid model selected by hybrid model selector 14 using a validation data set such as inspection images of the manufactured product, for example, and determines an acceptable threshold for the overdetection rate to inhibit false positives. Judgment threshold determiner 15 obtains judgments by inputting a validation data set such as inspection images of the manufactured product, for example, and judging whether each manufactured product is non-defective or defective. Judgment threshold determiner 15 generates a confusion matrix from the obtained judgments and determines an acceptable threshold for the overdetection rate (judgment threshold) to inhibit false positives. The cascading model indicated in threshold determination process 15a in FIG. 2 refers to the hybrid model that has been selected by hybrid model selector 14 and whose judgment threshold has been optimized.

### [2. Overview of Operations of Hybrid Model Creation Device 10]

Hereinafter, an overview of operations performed by hybrid model creation device 10 configured as described above will be given.

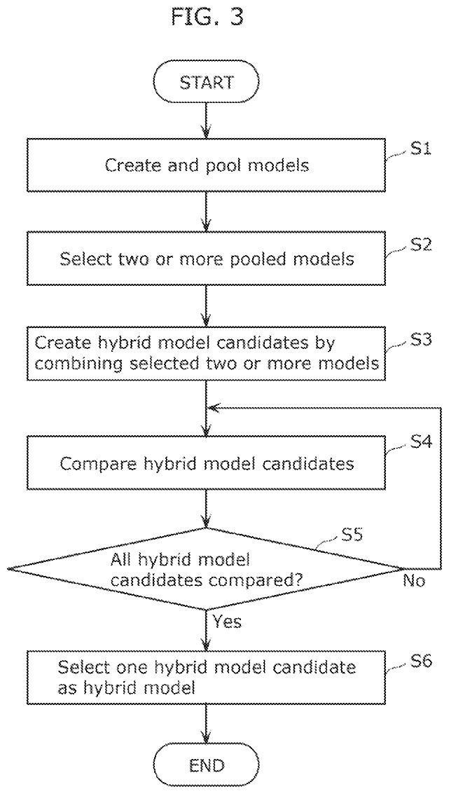

FIG. 3 is a flowchart illustrating an overview of operations performed by hybrid model creation device 10 according to the present embodiment.

First, hybrid model creation device 10 pools a plurality of models that predict the categories of input data (S1). In the present embodiment, at least one of the plurality of models is a model trained by machine learning. For example, each of the plurality of models takes an inspection image of a manufactured product as input, and predicts and outputs the probability that the manufactured product in the inspection image is defective.

Next, hybrid model creation device 10 selects two or more models from the pooled plurality of models (S2). In the present embodiment, hybrid model creation device 10 selects two or more models from the pooled plurality of models, excluding one or more models (predetermined models).

Next, by combining the two or more models selected in step S2, hybrid model creation device 10 creates a plurality of hybrid model candidates that judge the categories of input data (S3). In the present embodiment, hybrid model creation device 10 may combine the two or more models selected in step S2 by sequentially cascading them or by using logistic regression.

Next, hybrid model creation device 10 compares the plurality of hybrid model candidates created in step S3 (S4). In the present embodiment, hybrid model creation device 10 can, for example, compare the accuracy of the judgments of each of the hybrid model candidates, and can compare the importance of each of the two or more constituent models, which can be calculated from the judgments of the corresponding hybrid model candidate.

Next, hybrid model creation device 10 determines whether all hybrid model candidates have been compared (S5). In step S5, if not all hybrid model candidates have been compared (No in S5), processing returns to step S4.

However, in step S5, if all hybrid model candidates have been compared (Yes in S5), one of the plurality of hybrid model candidates is selected as the hybrid model (S6). In the present embodiment, hybrid model creation device 10 can select, as the hybrid model, a hybrid model candidate that consists of the most accurate or most important combination of models among the judgments of the hybrid model candidates.

Thus, with the hybrid model creation method according to present embodiment, a plurality of hybrid model candidates are created without using all of the pooled models, and the plurality of hybrid model candidates are compared using, for example, judgment accuracy. This allows, for example, the hybrid model candidate with the most accurate judgments to be selected as the hybrid model. Stated differently, a plurality of models can be used to create a more accurate hybrid model.

### Implementation Example 1

In step S1 illustrated in FIG. 3, a model with low prediction accuracy may be excluded as the predetermined model from the pooled models. Stated differently, among the pooled models, a model with low prediction accuracy may be excluded from the hybrid model candidates. Hereinafter, a specific example of this case will be described as Implementation Example 1. Note that prediction accuracy is not limited to the correct answer rate, and may be any combination of at least one of the following: the fit rate, the repeatability rate, the F-measure calculated by the harmonic mean of the fit rate and the repeatability rate, the area under curve (AUC) of the receiver operating characteristic (ROC) curve, and the correct answer rate.

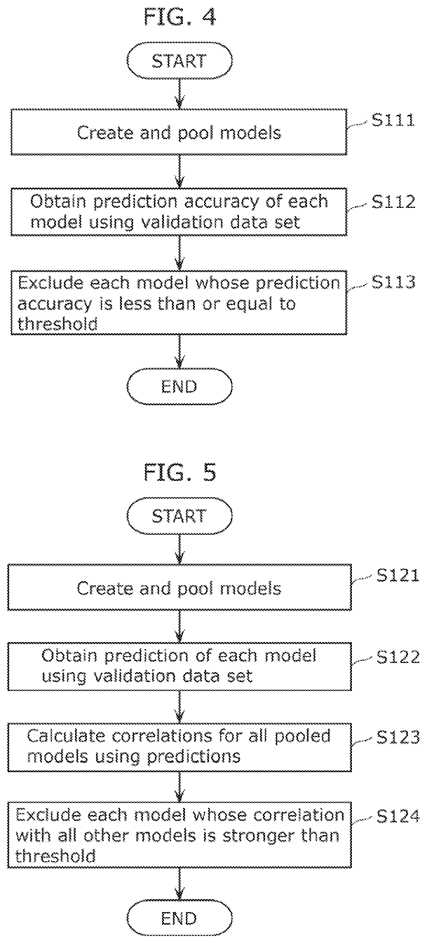

FIG. 4 is a flowchart illustrating one example of the detailed processing of step S1 in Implementation Example 1.

In step S1, first, hybrid model creation device 10 pools a plurality of models that predict the categories of input data (S111).

Next, hybrid model creation device 10 obtains the prediction accuracy of each of the models using a validation data set (S112). More specifically, before selecting two or more models, model selector 12 obtains the prediction accuracy of each of the models pooled in model pool 11 by inputting a plurality of validation data sets into the models and causing the models to predict the categories of the validation data sets.

Note that in one non-limiting example, the prediction accuracy of each of the pooled models may be calculated using the whole pre-prepared validation data set. Of the whole validation data set, part of the validation data set for which different models give different results may be used. For example, if the pooled models are model 1, model 2, model 3, and model 4, a validation data set where model 1 prediction is different from model 2, model 3, and model 4 prediction may be used.

Next, hybrid model creation device 10 excludes each model whose prediction accuracy is less than or equal to a threshold (S113). More specifically, model selector 12 excludes each model whose prediction accuracy is less than or equal to a threshold from the models pooled in model pool 11. Model selector 12 then selects two or more models from the models remaining after excluding each model whose prediction accuracy is less than or equal to the threshold. The threshold is set by the user in advance.

For example, if the pooled models are model 1, model 2, model 3, and model 4, and only the prediction accuracy of model 4 is less than or equal to the threshold, model selector 12 excludes model 4 from models 1 through 4 pooled in model pool 11. Model selector 12 then selects two or more models from model 1, model 2, and model 3 pooled in model pool 11.

In this way, hybrid model creation device 10 can exclude each pooled model whose prediction accuracy is less than or equal to a threshold from the hybrid model candidates.

### Implementation Example 2

In step S1 illustrated in FIG. 3, a model having a strong correlation with all other models may be excluded as the predetermined model from the pooled models. Stated differently, among the pooled models, a model having a strong correlation with all other models may be excluded from the hybrid model candidates. Hereinafter, a specific example of this case will be described as Implementation Example 2.

FIG. 5 is a flowchart illustrating one example of the detailed processing of step S1 in Implementation Example 2.

In step S1, first, hybrid model creation device 10 pools a plurality of models that predict the categories of input data (S121).

Next, hybrid model creation device 10 obtains the predictions of each of the models using a validation data set (S122). More specifically, before selecting two or more models, model selector 12 obtains the predictions of each of the models pooled in model pool 11 by inputting a plurality of validation data sets into the models and causing the models to predict the categories of the validation data sets. Here, the prediction may be the final output of the model, and, alternatively, may be an intermediate quantity of the model. For example, in a deep learning model, the prediction is the output of an intermediate layer or the final layer of the deep learning model.

Next, hybrid model creation device 10 calculates the correlations for all of the pooled models using the predictions obtained in step S122 (S123). More specifically, model selector 12 calculates the correlation between each pair of all models pooled in model pool 11.

Here, the correlation calculation method will be described.

Let cⱼ be the j-th (j is a natural number) model prediction for the validation data set. Let c_{j,i} be, for example, the prediction for the i-th (i is a natural number) validation data in the validation data set. Let the prediction be the final output or a scalar intermediate quantity of the model.

In this case, the correlation between the j-th and k-th (k is natural number and j≠k) models can be calculated using Expression 1, Expression 2, Expression 3, or Expression 4. Note that Expression 1 is an expression for calculating the rate of agreement (Jcacard coefficient) of the predictions and can be used when the predictions are binary values of 0 or 1. In Expression 1, δ is Kronecker's δ.

$$[ Math . 1 ]$$

$$\frac{1}{N} {\sum }_{i = 1}^{N} {δ}_{{c}_{j , i} , {c}_{h , i}} \qquad Expression 1$$

$$[ Math . 2 ]$$

$$cov ( {c}_{j} , {c}_{k} ) = E [ {c}_{j} {c}_{k} ] - E [ {c}_{j} ] E [ {c}_{k} ] \qquad Expression 2$$

$$[ Math . 3 ]$$

$$ρ ( {c}_{j} , {c}_{k} ) = \frac{cov ( {c}_{j} , {c}_{k} )}{\sqrt{V [ {c}_{j} ] V [ {c}_{k} ]}} \qquad Expression 3$$

$$[ Math . 4 ]$$

$$cos ( {c}_{j} , {c}_{k} ) = \frac{{c}_{j} \cdot {c}_{k}}{\vert {c}_{j} \vert \vert {c}_{k} \vert} \qquad Expression 4$$

Expression 2 through Expression 4 can be used not only when the predictions are binary, but also when the predictions are continuous values. Expression 2 is an expression for calculating covariance, and E[X] denotes the mean of X. In Expression 3, V[X] denotes the variance of X. Expression 3 is an expression for calculating the correlation coefficient, and Expression 4 is an expression for calculating cosine similarity, where c; is a vector made by arranging c_{j,k} with respect to i.

Next, how correlation is calculated when the predictions are intermediate quantities of vectors will be described.

In this case, the correlation between the j-th and k-th models can be calculated using Expression 5 or Expression 6 to calculate intermediate quantity similarity simᵢ for each instance of validation data. Note that f_{j,i} is the intermediate quantity of a vector of a plurality of values. Then, a statistic such as the median or the mean value shown in Expression 7 is calculated. This allows the calculated correlations to be compared even if the predictions are intermediate quantities of vectors.

$$[ Math . 5 ]$$

$${sim}_{i} = \frac{{f}_{j , i} \cdot {f}_{k , i}}{\vert {f}_{j , i} \vert \vert {f}_{k , i} \vert} \qquad Expression 5$$

$$[ Math . 6 ]$$

$$\begin{matrix}{sim}_{i} = ‖ {f}_{j , i} - {f}_{k , i} ‖ & Expression 6\end{matrix}$$

$$[ Math . 7 ]$$

$$average ( sim ) = \frac{1}{N} {\sum }_{i = 1}^{N} {sim}_{i} \qquad Expression 7$$

We will now return to the operations of FIG. 5.

Next, based on the correlations calculated in step S123, hybrid model creation device 10 excludes each model whose correlation with all other models is stronger than a threshold (S124). More specifically, model selector 12 excludes each model whose mean or median correlation coefficient with all other models is stronger the threshold from the models pooled in model pool 11. Model selector 12 then selects two or more models from the models remaining after excluding each model whose prediction accuracy is less than or equal to the threshold. The threshold is set by the user in advance.

For example, if the pooled models are model 1, model 2, model 3, and model 4, and the correlation between model 4 and the other models 1, 2 and 3 is stronger than the threshold, model selector 12 excludes model 4 from models 1 through 4 pooled in model pool 11. Model selector 12 then selects two or more models from model 1, model 2, and model 3 pooled in model pool 11.

In this way, hybrid model creation device 10 can exclude each pooled model whose correlation with all other models is stronger than a threshold from the hybrid model candidates.

### Implementation Example 3

Implementation Example 2 describes a case in which, in step S1 illustrated in FIG. 3, models with a strong correlation with all other models are excluded as predetermined models from the pooled models. In step S3 illustrated in FIG. 3, the hybrid model candidates may be created by not including combinations of strongly correlated models. Hereinafter, a specific example of this case will be described as Implementation Example 3.

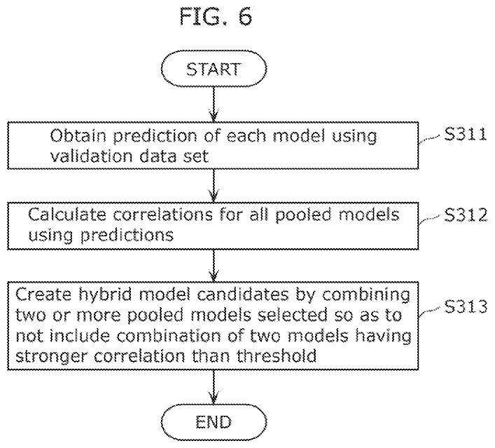

FIG. 6 is a flowchart illustrating one example of the detailed processing of step S3 in Implementation Example 3.

In step S3, first, hybrid model creation device 10 obtains the predictions of each of the models using a validation data set (S311). More specifically, before creating the plurality of hybrid model candidates, hybrid model candidate creator 13 obtains the predictions of each of the models pooled in model pool 11 by inputting a plurality of validation data sets into the models and causing the models to predict the categories of the validation data sets. Note that hybrid model candidate creator 13 may obtain the predictions of each of the models selected by model selector 12 by inputting a plurality of validation data sets into the models and causing the models to predict the categories of the validation data sets. Here, just as described in Implementation Example 2, the prediction may be the final output of the model, and, alternatively, may be an intermediate quantity of the model. For example, in a deep learning model, the prediction is the output of an intermediate layer or the final layer of the deep learning model.

Next, hybrid model creation device 10 calculates the correlations for all of the pooled or selected models using the predictions obtained in step S311 (S312). More specifically, hybrid model candidate creator 13 calculates the correlation between each pair of all models pooled in model pool 11 or selected by model selector 12. As the correlation calculation method has already been described in Implementation Example 2, repeated description will be omitted.

Next, hybrid model creation device 10 selects two or more models from the pooled plurality of models so as not to include a combination of two models having a stronger correlation than a threshold (S313). More specifically, hybrid model candidate creator 13 creates a plurality of hybrid model candidates by combining two or more models selected by model selector 12 so as not to include a combination of two models having a stronger correlation than a threshold.

In this way, hybrid model creation device 10 can create a hybrid model candidate that combines weakly correlated models from the selected models.

Next, the reason for creating a hybrid model candidate that combines weakly correlated models will be described.

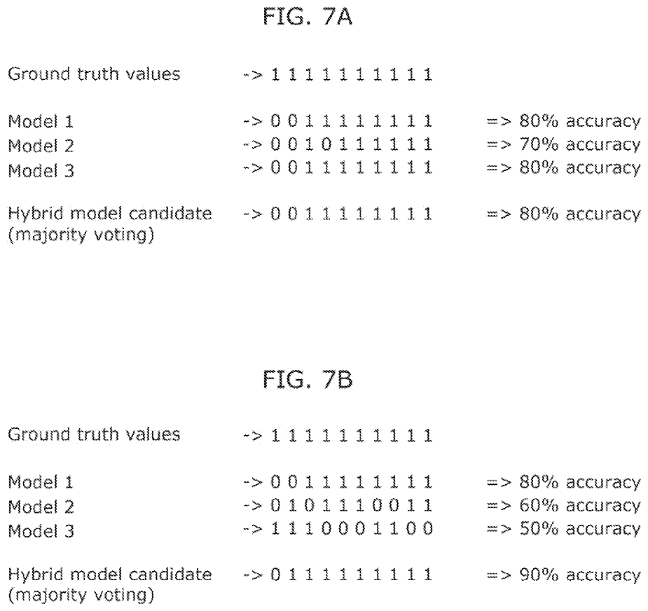

FIG. 7A is for illustrating the accuracy of a hybrid model candidate when three strongly correlated models are combined in Implementation Example 3. FIG. 7B is for illustrating the accuracy of a hybrid model candidate when three weakly correlated models are combined in Implementation Example 3. The hybrid model candidates illustrated in FIG. 7A and FIG. 7B combine the predictions of three models using, for example, logistic regression. For the sake of simplicity, the hybrid model candidates in FIG. 7A and FIG. 7B will be described as outputting the majority vote of the predictions of the three models.

FIG. 7A illustrates the binary predictions and judgments when 10 instances of validation data from the validation data set are used for each of the strongly correlated models 1, 2, and 3 and the hybrid model candidate, as well as illustrates the ground truth values of the instances of validation data. As illustrated in FIG. 7A, the accuracies (prediction accuracies) of model 1, model 2, and model 3 are 80%, 70%, and 80%, respectively, and the accuracy (judgment accuracy) of the hybrid model candidate combining model 1, model 2, and model 3 is 80%.

FIG. 7B illustrates the binary predictions and judgments when 10 instances of validation data from the validation data set are used for each of the weakly correlated models 1, 2, and 3 and the hybrid model candidate, as well as illustrates the ground truth values of the instances of validation data. As illustrated in FIG. 7B, the accuracies (prediction accuracies) of model 1, model 2, and model 3 are 80%, 60%, and 50%, respectively, and the accuracy (judgment accuracy) of the hybrid model candidate combining model 1, model 2, and model 3 is 90%.

As this shows, combining three strongly correlated models does not improve the accuracy of the hybrid model candidate. On the other hand, even if the accuracy of the three weakly correlated models is not high, the accuracy of the hybrid model candidate that combines the three weakly correlated models can be improved.

In this way, according to Implementation Example 3, hybrid model creation device 10 can create a hybrid model candidate that combines weakly correlated models. Hybrid model creation device 10 can then choose one hybrid model from such hybrid model candidates, and can thus create a more accurate hybrid model.

### Implementation Example 4

Implementation Example 4 describes a specific example in which logistic regression, for example, is used to create hybrid model candidates.

In the present implementation example, hybrid model candidate creator 13 uses, for example, logistic regression to combine two or more models selected by model selector 12 to create a plurality of hybrid model candidates that judge the categories. Although the maximum number of models to be combined is set in advance, it may re-set each time a hybrid model candidate is created. Hybrid model candidate creator 13 creates each hybrid model candidate as a machine learning model. A machine learning model is a model that takes, as input, two or more outputs obtained by inputting a validation data set into each of the two or more models selected to compose the hybrid model candidate and causing each of the two or more models to predict the categories of the validation data set, and outputs judgments obtained by judging the categories of the validation data set.

Hybrid model candidate creator 13 also compares the judgments output by the created hybrid model candidates. More specifically, hybrid model candidate creator 13 compares the judgments output by the created hybrid model candidates after machine learning.

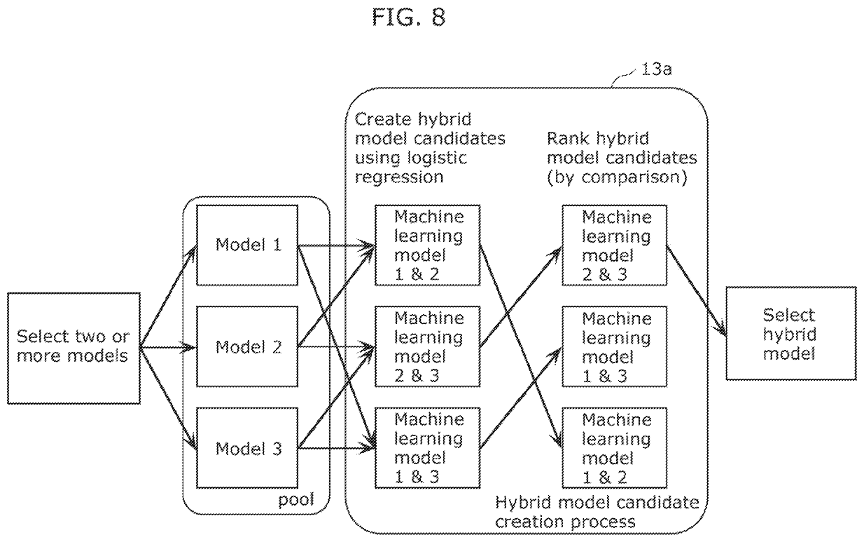

FIG. 8 is for conceptually illustrating of one example of the specifics of hybrid model candidate creation process 13a in Implementation Example 4. Hybrid model candidate creation process 13a illustrated in FIG. 8 is one example of the specifics of hybrid model candidate creation process 13a illustrated in FIG. 2.

In the example illustrated in FIG. 8, hybrid model candidate creator 13 performs hybrid model candidate creation process 13a of creating hybrid model candidates by combining model 1, model 2, and model 3 selected by model selector 12. More specifically, hybrid model candidate creator 13 creates machine learning model 1 & 2 (hybrid model candidate 1) that combines, for example, model 1 and model 2 using logistic regression. Hybrid model candidate creator 13 also creates machine learning model 2 & 3 (hybrid model candidate 2) that combines, for example, model 2 and model 3 using logistic regression. Hybrid model candidate creator 13 also creates machine learning model 1 & 3 (hybrid model candidate 3) that combines, for example, model 1 and model 3 using logistic regression. Note that in the example illustrated in FIG. 8, the machine learning models are created by combining the models using a brute force approach where the maximum number of models to be combined is 2.

In the example illustrated in FIG. 8, hybrid model candidate creator 13 obtains the outputs (judgments) output after training machine learning model 1 & 2, machine learning models 2 & 3, and machine learning model 1 & 3 with the validation data set. Hybrid model candidate creator 13 performs a comparison process of comparing the outputs of machine learning model 1 & 2, machine learning model 2 & 3, and machine learning model 1 & 3. Hybrid model candidate creator 13 ranks the results of the comparison process in order of accuracy, for example. In the example illustrated in FIG. 8, machine learning model 2 & 3, machine learning model 1 & 3, and machine learning model 1 & 2 are ranked in the listed order.

Here, we will describe how the models are combined using logistic regression.

A machine learning model obtained by combining models using logistic regression can be expressed using a logistic function (sigmoid function), as illustrated in Expression 8 below. Although two models are combined in Expression 8, the same applies when three or more models are combined.

$$[ Math . 8 ]$$

$$p = \frac{{β}_{0} + {β}_{1} {x}_{1} + {β}_{2} {x}_{2}}{{β}_{0} + {β}_{1} {x}_{1} + {β}_{2} {x}_{2} + 1} = \frac{1}{1 + b ( {β}_{0} + {β}_{1} {x}_{1} + {β}_{2} {x}_{2} )} = {S}_{b} ( {β}_{0} + {β}_{1} {x}_{1} + {β}_{2} {x}_{2} ) \qquad Expression 8$$

In Expression 8, the function S_{b}(β₀+β₁x₁+β₂x₂) is a sigmoid function that outputs a value from 0 to 1. β₀ is a constant, and β₁ and β₂ are coefficients of x₁ and x₂. x₁ and x₂ indicate the outputs of the two models.

In the present implementation example, x₁ and x₂ correspond to the outputs (predictions) after training each of the two models, and are expressed in terms of probabilities. The output of the function S_{b}(β₀+β₁x₁+β₂x₂) corresponds to the output (judgment) after the machine learning model combining the two models is trained with the coefficients using the validation data set, and is expressed as a probability ranging from 0 to 1.

For example, machine learning model 1 & 2, which is obtained by combining models using logistic regression, is a hybrid model candidate that takes the output of model 1 and the output of model 2 as inputs and acts on a logistic function whose coefficients are trained using a validation data set to produce and output a judgment. Similarly, machine learning model 2 & 3, which is obtained by combining models using logistic regression, is a hybrid model candidate that takes the output of model 2 and the output of model 3 as inputs and acts on a logistic function whose coefficients are trained using a validation data set to produce and output a judgment. Similarly, machine learning model 1 & 3, which is obtained by combining models using logistic regression, is a hybrid model candidate that takes the output of model 1 and the output of model 3 as inputs and acts on a logistic function whose coefficients are trained using a validation data set to produce and output a judgment.

Models may be combined using a method other than logistic regression. So long as the output (predictions) after training each of the plurality of models can be used as input for machine learning, other machine learning methods such as support vector machines, random forests, gradient boosting methods, and neural networks can be selected as appropriate.

Next, processes performed by hybrid model creation device 10 according to Implementation Example 4 will be described.

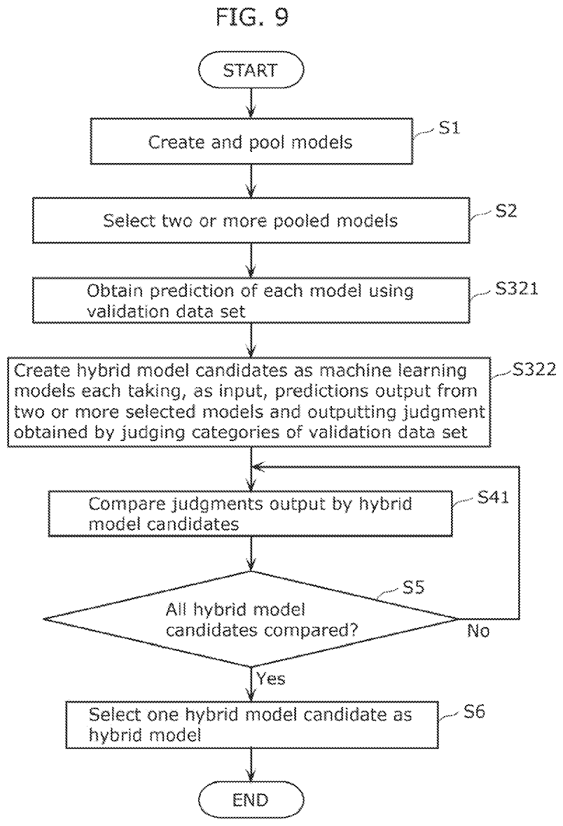

FIG. 9 is a flowchart illustrating one example of processes performed by hybrid model creation device 10 according to Implementation Example 4. Steps S1, S2, S5, and S6 illustrated in FIG. 9 are the same as steps S1, S2, S5, and S6 illustrated in FIG. 3. Accordingly, repeated description thereof will be omitted.

In step S321, hybrid model creation device 10 obtains the predictions of each of the models using a validation data set. More specifically, hybrid model candidate creator 13 obtains the predictions of each of the models pooled in model pool 11 or selected by model selector 12 by inputting a plurality of validation data sets into the models and causing the models to predict the categories of the validation data sets. As described above, the prediction may be the final output of the model, and, alternatively, may be an intermediate quantity of the model. Note that when predictions are to be obtained for each of the models pooled in model pool 11, step S321 may be performed before step S2.

Next, hybrid model creation device 10 creates a plurality of hybrid model candidates that combine the two or more models selected in step S2 as machine learning models (S322).

Here, each of the plurality of hybrid model candidates is a machine learning model that takes the predictions output from the two or more models selected as a combination as input and outputs judgments obtained by judging the categories of the validation data set. Each machine learning model is typically obtained by using logistic regression to combine two or more models selected as a combination. Each machine learning model is created by hybrid model candidate creator 13 in accordance with user instructions.

Next, hybrid model creation device 10 compares judgments output by each of the plurality of hybrid model candidates created in step S322 (S41). More specifically, hybrid model candidate creator 13, for example, inputs the validation data set into each of the hybrid model candidates and compares the accuracy of the output judgments.

Hybrid model candidate creator 13 may compare the importance of each of the two or more constituent models, which can be calculated from the judgments of the corresponding hybrid model candidate. More specifically, when comparing the plurality of hybrid model candidates, hybrid model candidate creator 13 may, for each of the plurality of hybrid model candidates, calculate the importance of each of the two or more models selected to compose the hybrid model candidate from the judgments output by the hybrid model candidate. Hybrid model candidate creator 13 may then perform the comparison process of step S41 by reporting models calculated as having an importance below a preset threshold.

Hybrid model candidate creator 13 may report these models to hybrid model selector 14, and may report these models by displaying them on a display or the like. This allows hybrid model selector 14 to select one of the plurality of hybrid model candidates, excluding hybrid model candidates including a model whose importance is below the preset threshold, as the hybrid model in step S6.

Hereinafter, the method used to compare importance (contribution) will be described.

As described above, in Expression 8, the output of the function S_{b}(β₀+β₁x₁+β₂x₂) corresponds to the output (judgment) after the machine learning model combining the two models is trained with the coefficients using the validation data set. Coefficient β₁ indicates the importance of the model that outputs x₁ in this machine learning model, and coefficient β₂ indicates the importance of the model that outputs x₂ in this machine learning model. Stated differently, coefficient βᵢ indicates the importance of model i that outputs x₁ in a machine learning model that combines a plurality of models.

Here, if coefficient βᵢ is 0, or if coefficient βᵢ is smaller than the other coefficients βₖ(i≠k), model i can be analyzed as having a small impact on (contribution to) the judgment by the machine learning model.

If coefficient βᵢ is negative, model i can be analyzed as a possible cause of overtraining of the machine learning model. This is because it is believed that the judgments of a machine learning model and each of the plurality of models that compose the machine learning model should be positively correlated.

Thus, a machine learning model combining a plurality of models can be analyzed in regard to the importance of each of the combined models by training with the coefficients and analyzing the coefficients using the validation data set.

If coefficient βᵢ is 0 or smaller than the other coefficients βₖ, or if coefficient βᵢ is negative, then model i should not be used as a model in the combination of models that compose the machine learning model.

Thus, when combining plurality of models using logistic regression, it is easy to calculate the importance of each of the models being combined. However, other machine learning models may not be able to use the coefficient analysis method described above. However, by using SHapley Additive exPlanations (SHAP), which is a way of interpreting the contributions of features of inferences, it is possible to calculate the importance of each of the models being combined.

### Implementation Example 5

The plurality of models may include computationally expensive models. In such cases, a hybrid model candidate created by combining computationally expensive models may not meet hardware or computation time requirements. Note that even when the computation time is within the requirements, a faster processing speed is still considered better.

Therefore, in Implementation Example 5, when hybrid model candidates are created by machine learning using logistic regression, processing speed is taken into account. Hereinafter, a specific example will be given.

One method of taking processing speed into account is to use the sum of the computation times of the models that compose the hybrid model candidate, and another method is to add a regularization term to the loss function during training by machine learning.

As a first method of taking processing speed into account, the method of using the sum of the computation times of the models that compose the hybrid model candidates will now be described.

First, hybrid model candidate creator 13 measures (obtains) the processing time required to predict the categories of the validation data set after inputting the validation data set into each of the models pooled in model pool 11 or selected by model selector 12. Here, we assume that the validation data set contains X samples.

Next, hybrid model candidate creator 13 calculates the average processing time for each of the plurality of models from the measured processing times. Here, the average processing time is a per-sample processing time.

Next, hybrid model candidate creator 13 creates a plurality of hybrid model candidates from only combinations, among the two or more models selected by model selector 12, having a total average processing time that meets the computation time requirement. Since the method of creating hybrid model candidates by machine learning using logistic regression has already been described in Implementation Example 4, repeated description will be omitted.

Next, as a second method of taking processing speed into account, the method of adding a regularization term to the loss function used in machine learning will be described.

First, hybrid model candidate creator 13 obtains the processing time required to predict the categories of the validation data set after inputting the validation data set into each of the models pooled in model pool 11 or selected by model selector 12. Here, we assume that the validation data set contains X samples.

Next, hybrid model candidate creator 13 calculates the average processing time for each of the plurality of models from the obtained processing times. Here, the average processing time is a per-sample processing time. Hybrid model candidate creator 13 defines hardware cost as the value of the average processing time of each of the models relative to the sum of the average processing times of all of the models.

Stated differently, hardware cost Cₘ can be defined as shown in Expression 9 below.

cₘ=avg(model inference speed)/sum(avg_all_models inference speed) Expression 9

Since the method of creating hybrid model candidates by machine learning using logistic regression has already been described in Implementation Example 4, repeated description will be omitted.

Next, in each of the plurality of hybrid model candidates, hybrid model candidate creator 13 adds a regularization term, which takes into account the hardware cost of each of the two or more models selected to compose the hybrid model candidate, to the loss function of the machine learning model of the hybrid model candidate.

The regularization term that takes into account hardware cost can be expressed, for example, as α·Cₘ·L1, which is obtained by multiplying a regularization term such as Lasso (L1 norm or L1 regularization) multiplied by parameter α and hardware cost Cₘ. Here, parameter α is a hyperparameter that can change the weight of the hardware cost. This will be described in greater detail later.

Next, hybrid model candidate creator 13 performs logistic regression machine learning after adding a regularization term that takes hardware cost into account. This makes it possible to reduce the coefficients (weights) of models that are computationally expensive yet offer little contribution to the hybrid model candidates, thus making it possible to exclude models that contribute little to the hybrid model candidates.

Here, a detailed example of a method of adding hardware cost as a regularization term will be given.

The loss function E(w) of the logistic regression is expressed as shown in Expression 10, where N is the number of instances of data in the data set used for training, tₙ is the true value of the n-th data in the data set, and φₙ is the set of explanatory variables for the n-th data. The machine learning learns to obtain a combination of weights (coefficients) that minimizes the loss function E(w).

$$[ Math . 9 ]$$

$$E ( w ) = - {\sum }_{n = 1}^{N} {t}_{n} ln {y}_{n} + ( 1 - {t}_{n} ) ln ( 1 - {y}_{n} ) \qquad Expression 10$$

$${y}_{n} = σ ( {w}^{T} {ϕ}_{n} ) = \frac{1}{1 - exp ( - {w}^{T} {ϕ}_{n} )}$$

A loss function E′(w), for example, with the L1 regularization term added to the loss function E(w), is expressed as shown in Expression 11, where m is the number of dimensions of the explanatory variables. In Expression 11, parameter a is a hyperparameter.

$$[ Math . 10 ]$$

$$\begin{matrix}{E}^{′} ( w ) = E ( w ) + α {\sum }_{m = 1}^{M} \vert {w}_{m} \vert & Expression 11\end{matrix}$$

In the present implementation example, the explanatory variable is the output value of each model. Thus, using hardware cost Cₘ of the corresponding model, the loss function E′(w), which takes into account hardware cost, can be expressed as shown in Expression 12.

$$[ Math . 11 ]$$

$${E}^{′} ( w ) = E ( w ) + α {\sum }_{m = 1}^{M} {c}_{m} \vert {w}_{m} \vert \qquad Expression 12$$

Although a method of adding hardware cost as a regularization term in the case of logistic regression has been described, methods are not limited thereto. Similarly, for general machine learning, by adding the second term on the right side of Expression 12 to the loss function E(w), it is possible to create the loss function E′(w) that takes hardware cost Cₘ into account.

Although the L1 regularization term is used as the regularization term in the above example, the L2 regularization term may be used. In this case, the loss function that takes hardware cost Cₘ into account can be defined the same way. Note that the L1 regularization term is expected to have the effect of not just reducing the values of the weights (coefficients), but making them 0. For this reason, it is better to use the L1 regularization term than the L2 regularization term for the purpose of creating a hybrid model candidate with a combination that excludes models with longer processing times.

Next, processes for creating hybrid model candidates according to Implementation Example 5 will be described.

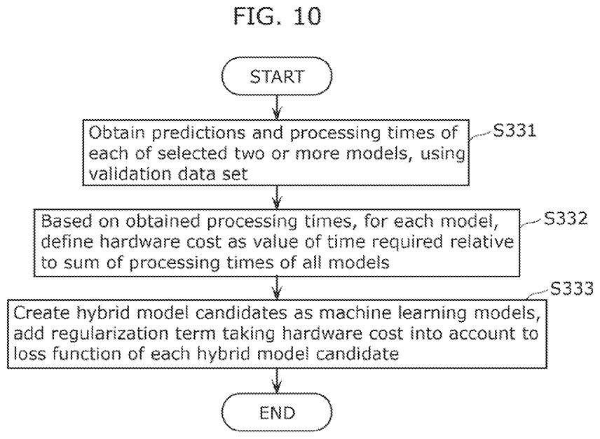

FIG. 10 is a flowchart illustrating one example of the detailed processing of step S3 in Implementation Example 5. FIG. 10 corresponds to another example of the processing of steps S321 and S322 illustrated in FIG. 9.

In step S3, hybrid model creation device 10 obtains the predictions and processing times of each of the models using a validation data set (S331). More specifically, hybrid model candidate creator 13 inputs a plurality of validation data sets into each of the models selected by model selector 12 and causes each of the models to predict the categories of the validation data sets. Hybrid model candidate creator 13 obtains the predictions and processing times required to predict the categories of the validation data set after inputting the validation data set into each of the models selected by model selector 12. As described above, the prediction may be the final output of the model, and, alternatively, may be an intermediate quantity of the model. Note that the processing times and the predictions may be obtained from each of the models pooled in model pool 11. In such cases, step S331 may be performed before step S2.

Next, based on the processing times obtained in step S331, for each model, hybrid model creation device 10 defines the hardware cost as the value of the time required by the model relative to the sum of the processing times of all of the models (S332). Here, the processing time used to define hardware cost is the average processing time.

Next, hybrid model creation device 10 creates a plurality of hybrid model candidates that combine the two or more models selected in step S2 as machine learning models. Here, hybrid model creation device 10 adds, to the loss function of each of the plurality of hybrid model candidates during training by machine learning, a regularization term that takes hardware cost into account (S333). More specifically, with respect to each of the hybrid model candidates, a regularization term that takes into account (is multiplied by) the hardware cost of each of the two or more models selected to compose the hybrid model candidate is added to the loss function of the hybrid model candidate.

Note that before comparing the plurality of hybrid model candidates in the subsequent step S4, hybrid model candidate creator 13 performs coefficient analysis from the outputs (judgments) obtained after training with the validation data set. This allows hybrid model candidate creator 13 to exclude hybrid model candidates that include a model with a long processing time. Therefore, in the subsequent step S4, hybrid model candidate creator 13 may compare the hybrid model candidates after excluding the each hybrid model candidate that includes a model with a long processing time.

### Implementation Example 6

A hybrid model candidate is created as a machine learning model that takes the predictions output from the two or more models selected as a combination as input and outputs judgments obtained by judging the categories of the validation data set, and is trained by machine learning. Implementation Example 6 describes a case in which a machine learning model is trained by machine learning, excluding predictions output from the two or more models that indicate a “clear” negative, which refers to a prediction that is a definite negative and whose ground truth value (label) is also negative.

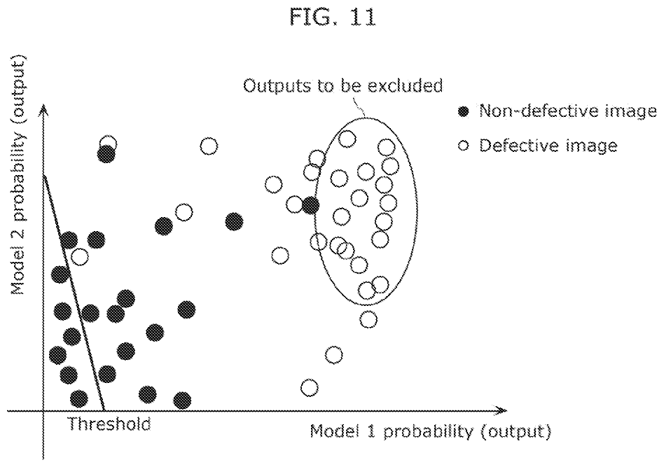

FIG. 11 conceptually illustrates one example of a hybrid model candidate created by combining model 1 and model 2 in Implementation Example 6. The hybrid model candidate illustrated in FIG. 11 is a logistic regression model (boundary) created by machine learning. The vertical axis is the output value that is output (predicted) when the validation data set is input to model 2, expressed as a probability. Similarly, the horizontal axis is the output value that is output (predicted) when the validation data set is input to model 1, expressed as a probability. In FIG. 11, assuming the sample data included in the validation data set is of inspection images of a manufactured product, the black circles are inspection images whose sample data ground truth value is non-defective, and are referred to as non-defective images, and the white circles are inspection images whose sample data ground truth value is defective, and are referred to as defective images.

When creating a hybrid model candidate, it is necessary to minimize the number of missed judgments, i.e., judging an inspection image whose ground truth value is defective as a non-defective image, to raise judgment accuracy. A missed judgment is a false positive judgment, i.e., judging a negative (ground truth value=defective) as a positive (non-defective). One way to raise judgment accuracy is machine learning using sample data with different predictions for each model, as described above. It is also important to have the outputs of model 1 and model 2 corresponding to non-defective images be close to the boundary in order to train them to be the logistic regression model (boundary) illustrated in FIG. 11. However, an output, indicating a defective image, for which the output values (probabilities) of both model 1 and model 2 are large (such an output is referred to as an output indicating a clear negative), is of relatively low importance when training to produce the logistic regression model (boundary) illustrated in FIG. 11.

In the example illustrated in FIG. 11, outputs in the region enclosed by the circle are outputs indicating a clear negative. There are a large number of clear negatives included in the region enclosed by the circle. Therefore, when creating a hybrid model candidate by machine learning using the outputs of model 1 and model 2 and the ground truth values (labels) of the validation data set as illustrated in FIG. 11, the machine learning may be strongly influenced by outputs that indicate a clear negative, such as those in the region enclosed by the circle, and may therefore not yield the boundary illustrated in FIG. 11.

In view of this, when creating a hybrid model candidate by machine learning, the outputs in the region enclosed by the circle that indicate a clear negative are excluded from the machine learning.

More specifically, hybrid model candidate creator 13 excludes each output value predicted to be defective due to being higher than a threshold from output values obtained by, for each of the plurality of hybrid model candidates, inputting a validation data set into each of the two or more models selected to compose the hybrid model candidate and causing each of the two or more models to predict the categories of the validation data set. Hybrid model candidate creator 13 then creates the plurality of hybrid model candidates by machine learning using the output values excluding each output value higher than the threshold as input and using the ground truth values of the validation data set corresponding to the output values used.

Next, processes for creating hybrid model candidates according to Implementation Example 6 will be described.

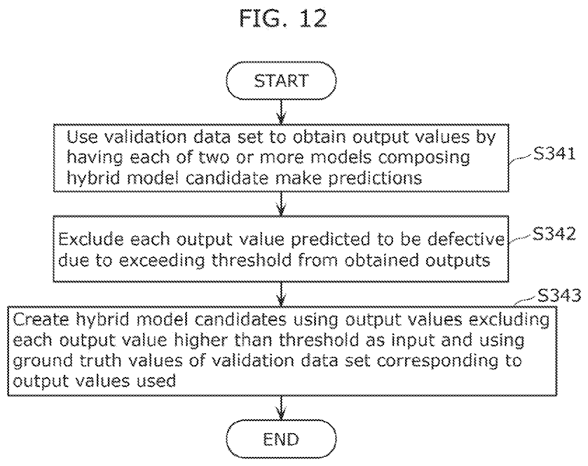

FIG. 12 is a flowchart illustrating one example of the detailed processing of step S3 in Implementation Example 6. FIG. 12 corresponds to another example of the processing of steps S321 and S322 illustrated in FIG. 9.

In step S3, hybrid model creation device 10 uses a validation data set to obtain a plurality of output values by having each of the two or more models that compose the hybrid model candidate make predictions (S341).

Next, hybrid model creation device 10 excludes each output value predicted to be defective due being higher than a threshold from the plurality of output values obtained in step S341 (S342). Here, each output value predicted to be defective due to being higher than the threshold is an output value that indicates a clear negative, as described with reference to FIG. 11.

Hybrid model creation device 10 then creates the plurality of hybrid model candidates by machine learning using the output values except each output value higher than the threshold that were excluded in step S342 as input and using the ground truth values of the validation data set corresponding to the output values used (S343).

In this way, hybrid model creation device 10 can create a plurality of hybrid model candidates with high judgment accuracy by machine learning that excludes outputs included in a region where clear negative outputs gather.

### Implementation Example 7

Implementation Example 6 describes a case in which machine learning is performed by excluding the outputs included in a region where clear negative outputs gather from among the outputs of each of the two or more models that compose the hybrid model candidate, but the present disclosure is not limited to this example. Implementation Example 7 describes using a convex envelope as another method of excluding outputs indicating a clear negative. Note that a convex envelope is the smallest convex polygon (convex polyhedron) that encompasses all given points.

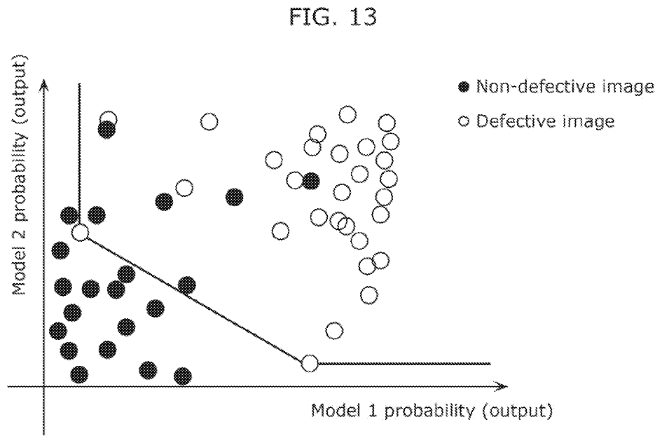

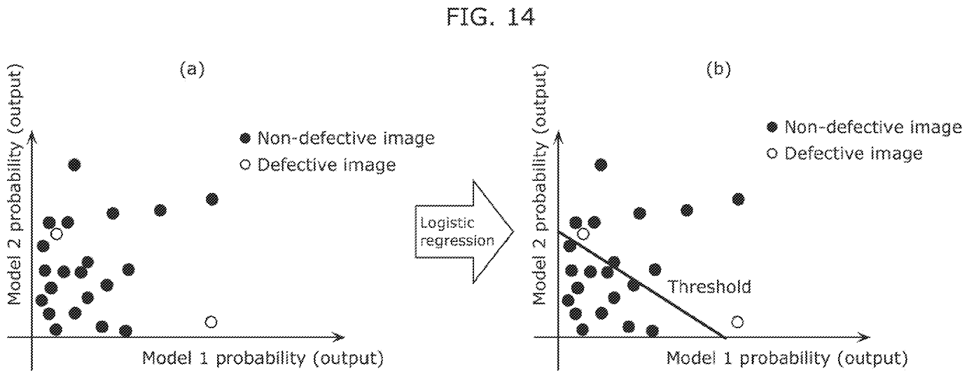

FIG. 13 conceptually illustrates outputs of model 1 and model 2 as well as a convex envelope of the distribution of outputs corresponding to defective images according to Implementation Example 7. FIG. 14 conceptually illustrates one example of a hybrid model candidate created from the outputs of model 1 and model 2, excluding each output corresponding to a defective image except the vertices of the convex envelope illustrated in FIG. 13. In FIG. 14, (a) conceptually illustrates the outputs of model 1 and model 2, with the outputs indicating negative removed except the vertices of the convex envelope illustrated in FIG. 13, and (b) conceptually illustrates one example of a logistic regression model (boundary) as a hybrid model candidate created by machine learning from the outputs of model 1 and model 2 shown in (a) in FIG. 14.

More specifically, hybrid model candidate creator 13 calculates a convex envelope from a plot of output values predicted to be defective among output values obtained by, for each of the plurality of hybrid model candidates, inputting a validation data set into each of the two or more models selected to compose the hybrid model candidate and causing each of the two or more models to predict the categories of the validation data set. Next, hybrid model candidate creator 13 excludes each output value included in the convex envelope from the plurality of output values, except the vertices of the convex envelope. Hybrid model candidate creator 13 then creates the plurality of hybrid model candidates by machine learning using the output values excluding each output value included in the convex envelope except the vertices of the convex envelope as input, and using the ground truth values of the validation data set corresponding to the output values used.

This makes it possible to create a hybrid model candidate with a judgment accuracy with zero misses (missed judgments).

Next, processes for creating hybrid model candidates according to Implementation Example 7 will be described.

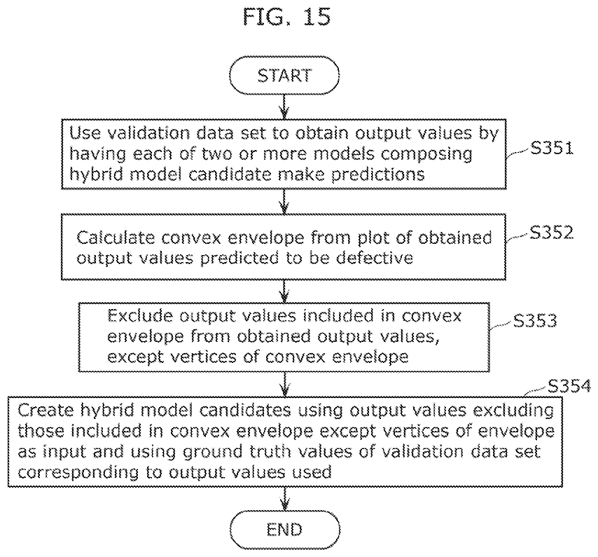

FIG. 15 is a flowchart illustrating one example of the detailed processing of step S3 in Implementation Example 7. FIG. 15 corresponds to another example of the processing of steps S321 and S322 illustrated in FIG. 9.

In step S3, hybrid model creation device 10 uses a validation data set to obtain a plurality of output values by having each of the two or more models that compose the hybrid model candidate make predictions (S351).

Next, hybrid model creation device 10 calculates a convex envelope from a plot of the output values obtained in step S351 that are predicted to be defective (S352).

Next, hybrid model creation device 10 excludes the output values included in the convex envelope from the plurality of output values obtained in step S351, except the vertices of the convex envelope (S353).

Hybrid model creation device 10 then creates the plurality of hybrid model candidates by machine learning using output values excluding those included in the convex envelope except the vertices of the convex envelope as input and using the ground truth values of the validation data set corresponding to the output values used (S354).

Thus, by using a convex envelope to exclude outputs indicating a clear negative, hybrid model creation device 10 can create a plurality of hybrid model candidates with high judgment accuracy with zero misses (missed judgments).

If a large number of models (number of dimensions), such as, for example, 10 or more, are selected to compose the hybrid model candidates, the method of using a convex envelope may not be viable since the number of vertices of the convex envelope will be extremely large and/or it will be computationally expensive.

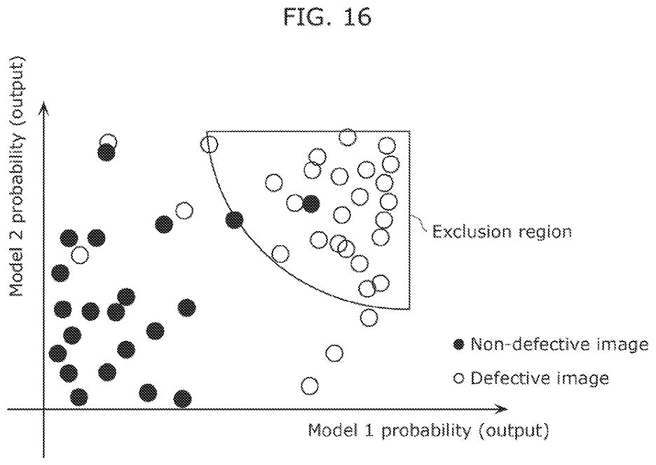

In such cases, as explained in Implementation Example 6, it is sufficient to exclude outputs that are included in a region where clear negatives gather (an exclusion region), as illustrated in FIG. 16.

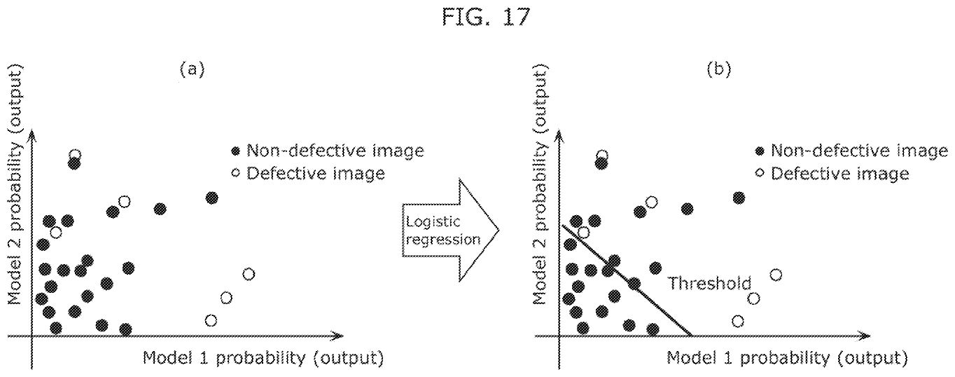

FIG. 16 conceptually illustrates the outputs of model 1 and model 2 and an exclusion region according to Implementation Example 7. FIG. 17 conceptually illustrates one example of a hybrid model candidate created from the outputs of model 1 and model 2, excluding each output corresponding to a defective image except that is included in the exclusion region illustrated in FIG. 16. In FIG. 17, (a) conceptually illustrates the outputs of model 1 and model 2, with the outputs indicating negative that are included in the exclusion region illustrated in FIG. 16 removed, and (b) conceptually illustrates one example of a logistic regression model (boundary) as a hybrid model candidate created by machine learning from the outputs of model 1 and model 2 shown in (a) in FIG. 17.

As illustrated in FIG. 16 and FIG. 17, it is sufficient to calculate an exclusion region as a region where outputs indicating clear negative, which has a large output value (probability) indicating negative and whose ground truth value (label) is also negative, in both the outputs of model 1 and model 2. Such a calculation method can be used as an approximate method of the convex envelope calculation. Machine learning may then be performed excluding outputs that indicate clear negative in the exclusion region.

Note that such an approximate method is also effective in the cases in which there are few dimensions. This is because when using the convex envelope method, the number of outputs of the model that can be used for machine learning becomes too few when there are only a few dimensions, and machine learning becomes unstable.

### Implementation Example 8

One comparison method for comparing a plurality of hybrid model candidates is to compare the judgments of each of the hybrid model candidates.

Here, judgments by machine learning are usually output as probabilities. However, a probability output as a judgment does not represent the actual probability of the category indicated as the judgment. For example, even if the judgment of whether a manufactured product shown in an inspection image input as sample data is defective is 0.9, the probability that the manufactured product is defective is not necessarily 90%; it is known that there is a difference between the actual probability and the judgment.

One known technique is confidence calibration, which adjusts the probability indicated as the AI judgment to the actual probability.

In this implementation example, the judgments output by the hybrid model candidates are converted into miss rates of the hybrid model candidates. FAR tables of the models selected to create a hybrid model candidate are calculated and used as a parameter for adjusting the miss rate of the hybrid model candidate.

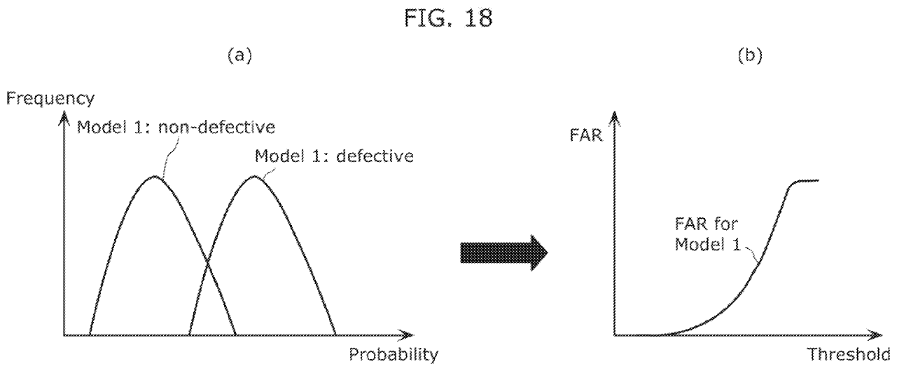

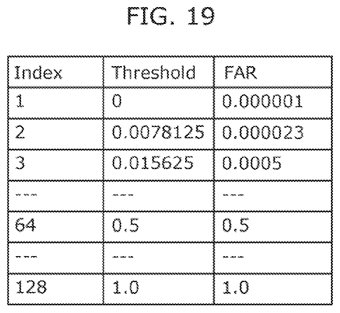

FIG. 18 illustrates a method of calculating a FAR curve for model 1 according to Implementation Example 8. FIG. 19 illustrates one example of a FAR table for model 1 according to Implementation Example 8. Model 1 is one of the plurality of models selected to create a hybrid model candidate.

Here, FAR stands for False Acceptance Rate, and is the probability of misjudging a negative (false) as a positive. In the present implementation example, the FAR value is also referred to as a miss rate. Also, FA stands for False Acceptance, and is the misjudgment of a negative (false) as a positive. In the implementation example, FA is also referred to as a miss or a missed judgment. The FAR table is a table of miss rates (FAR values) obtained using a variable threshold with a predetermined step size.

More specifically, first, during training by machine learning, hybrid model candidate creator 13 creates a FAR table for each of the models selected to create a hybrid model candidate, using the validation data set.

For example, using the example illustrated in FIG. 18, the first step is to obtain the output values and frequencies obtained by inputting the validation data set into model 1 and causing model 1 to predict the categories of the validation data set. Next, as illustrated in (a) in FIG. 18, the output values are stratified into a distribution of output values (probabilities) indicating non-defective from among the validation data set and the frequencies thereof and a distribution of output values (probabilities) indicating defective from among the validation data set and the frequencies thereof. Next, the FAR curve illustrated in (b) in FIG. 18 can be obtained by obtaining the surface area ratio of the output values judged as non-defective when the threshold is gradually increased in the distribution of output values (probabilities) indicating defective that is illustrated in (a) in FIG. 18. The surface area ratio when the surface area of the entire distribution is set as 1 corresponds to the miss rate (FAR value). The FAR table illustrated in FIG. 19 can be obtained by obtaining the miss rates (FAR values) at a predetermined step size in the distribution of output values (probabilities) indicating defective that is illustrated in (a) in FIG. 18. In the FAR table illustrated in FIG. 19, the step size is set to 0.0078125, and FAR values of 0 through 1 for the indices assigned per step size are listed.

Thus, for each of the models selected, hybrid model candidate creator 13 can create a FAR table from the distribution of output values obtained by inputting data that indicates defective in the validation data set into the model and causing the model to predict the categories of the data. Since hybrid model candidate creator 13 can obtain the miss rates by varying the threshold in the obtained output value distribution, hybrid model candidate creator 13 can create a FAR table of miss rates.

Next, hybrid model candidate creator 13 obtains predictions by inputting data samples included in the validation data set into each of the two or more models selected to compose the hybrid model candidate and causing each of the two or more models to predict the categories of the data samples. Hybrid model candidate creator 13 obtains first FAR values, which are FAR values of the two or more models corresponding to the data samples, by looking up the obtained predictions (output values) in the FAR table that has been prepared in advance.

Suppose that 0.99 is obtained as a prediction when a sample image of an inspection image whose ground truth value indicates defective is input to, for example, model 1 included in the hybrid model candidate. In this case, the FAR value corresponding to a prediction of 0.99 is obtained from the FAR table for model 1 illustrated in FIG. 19. More specifically, Table [(1−prediction)/step_size]=Table [(1−0.99)/0.0078125]=Table [1] can be calculated, and therefore the FAR value for Index=1 in the FAR table illustrated in FIG. 19 is obtained. This allows hybrid model candidate creator 13 to obtain a FAR value of 0.000023 as the first FAR value.

In this way, in the present implementation example, the probability that the inspection image is defective can be predicted (adjusted) based on the distribution of output values (probabilities) indicating defective when the FAR table is created.

Next, hybrid model candidate creator 13 multiplies the obtained first FAR values of each of the two or more models. With this, hybrid model candidate creator 13 can obtain a second FAR value, which is the FAR value of the hybrid model candidate of the combined two or more models.

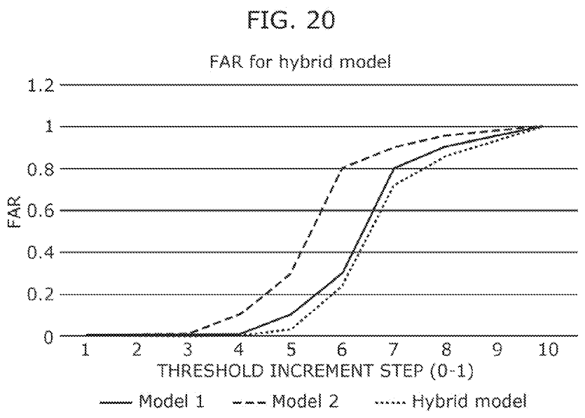

FIG. 20 conceptually illustrates the first FAR values of each of the two models and the second FAR value of the hybrid model candidate created by combining the two models according to Implementation Example 8. As illustrated in FIG. 20, the first FAR values of each of the two or more models can be multiplied to obtain a second FAR value that is improved over the first FAR values of each of the two or more models.

Here, the FAR distributions of the plurality of models that compose the hybrid model candidate are assumed to be independent. Therefore, by multiplying the first FAR values of each of the two or more models, by the probability rule of independent distribution, a second FAR value of the hybrid model candidate that combines the two or more models can be obtained.

If the FAR distributions of the plurality of models composing the hybrid model candidate are not independent, the correlation coefficients of all the plurality of models may be calculated and the second FAR value may be corrected so that the correlation coefficient with the best performance is dominant.

The correlation coefficients are calculated, for example, as follows. First, hybrid model candidate creator 13 obtains the predictions of each of the models selected for creating the plurality of hybrid model candidates by inputting a plurality of validation data sets into the models and causing the models to predict the categories of the validation data sets. Next, hybrid model candidate creator 13 may use the obtained predictions to calculate the correlation coefficients for all combinations of two of the plurality of models. With this, hybrid model candidate creator 13 can obtain a corrected second FAR value by multiplying the obtained first FAR values of each of the two or more models and then further multiplying the product by a factor that inversely correlates with the correlation coefficient.

Next, if the second FAR value is smaller than a preset threshold (FAR threshold), hybrid model candidate creator 13 judges that the corresponding data sample is non-defective. Hybrid model candidate creator 13 can take such a judgment as a judgment resulting from inputting this data sample into the hybrid model candidate. With this, hybrid model candidate creator 13 can obtain judgments adjusted using both the second FAR value and the preset threshold as judgments resulting from inputting data samples into the plurality of hybrid model candidates. Hybrid model candidate creator 13 can then compare the plurality of hybrid model candidates using the adjusted judgments.

Note that the FAR threshold may be determined in advance based on a permissible miss rate set by the user of the hybrid model.

For example, suppose that the user permits a miss rate of 1 ppm among inspection images whose ground truth value indicates defective, and sets the threshold (FAR threshold) in advance as 1/1,000,000. Also suppose the plurality of models that compose the hybrid model candidate are model 1 and model 2. In such a case, once the first FAR values for model 1 and model 2 for a given instance of sample data are obtained as described above, the second FAR value can be obtained by multiplying them. If the second FAR value is smaller than the FAR threshold of 1/1,000,000, the sample data can be judged as negative (i.e., indicating defective) and positive (i.e., indicating non-defective) if it is larger.

With the above embodiments and implementation examples, hybrid model creation device 10 and the hybrid model creation method according to the present disclosure can create a hybrid model that does not use all of the plurality of models that have been prepared and pooled in advance. Moreover, since hybrid model creation device 10 and the hybrid model creation method according to the present disclosure can create hybrid model candidates that exclude models that are computationally expensive yet offer little contribution from the viewpoint of processing speed, a hybrid model can be created in a lightweight and effective manner. Furthermore, since hybrid model creation device 10 and the hybrid model creation method according to the present disclosure can create hybrid model candidates that exclude models that do not contribute to an improvement in accuracy using importance as a factor, a hybrid model can be created in a lightweight and effective manner.

Although hybrid model creation device 10 and the like according to the present disclosure have been described based on embodiments and implementation examples, the present disclosure is not limited to these embodiments and implementation examples. Various modifications of the embodiments and implementation examples as well as embodiments resulting from arbitrary combinations of elements of different embodiments or implementation examples that may be conceived by those skilled in the art are intended to be included within the scope of the present disclosure as long as these do not depart from the essence of the present disclosure.

### Other Embodiments

(1) In the above embodiments, hybrid model creation device 10 selected one hybrid model by creating hybrid model candidates that combine, using, for example, logistic regression, a plurality of models selected from a plurality of pooled models, and comparing the hybrid model candidates, but this example is non-limiting. For example, hybrid model candidates may be created by combining a plurality of models selected from a plurality of pooled models and performing a prediction process with logical formulas in the sequence in which the models were combined, and then selecting a single hybrid model by comparing the accuracies.

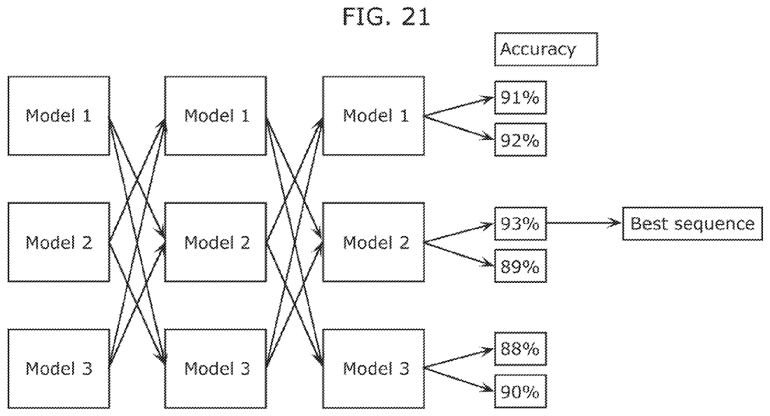

FIG. 21 illustrates one example of a hybrid model creation method according to another embodiment.

FIG. 21 illustrates a hybrid model creation method for when model 1, model 2, and model 3 are selected from the plurality of pooled models. In FIG. 21, hybrid model candidates are created by combining the three different models connected by arrows in the connected sequence. Hybrid model candidates are compared in terms of accuracy by taking the logical OR or logical product of their respective precisions in the sequence in which model 1, model 2, and model 3 were combined. The example illustrated in FIG. 21 indicates that the hybrid model candidate with the combination sequence of model 3-model 1-model 2 has the highest accuracy of 93% and is therefore selected as the hybrid model.

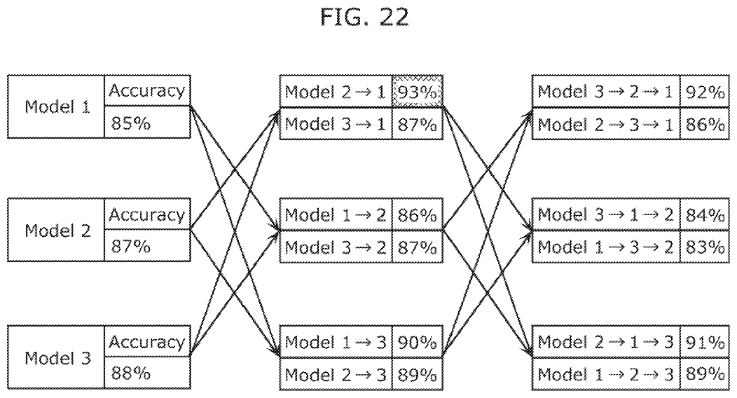

FIG. 22 illustrates another example of a hybrid model creation method according to another embodiment. FIG. 22 illustrates a method of creating hybrid model candidates that combine at least two or more of model 1, model 2, and model 3 when model 1, model 2, and model 3 are selected from a plurality of pooled models. In FIG. 22, the hybrid model candidate that combines model 2 and model 1 in this sequence is selected as the hybrid model because it has the highest accuracy of 93%.

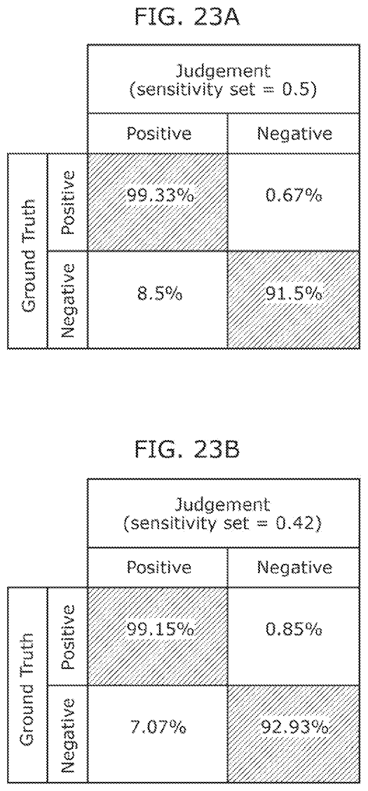

(2) In the above embodiments, judgment threshold determiner 15 included in hybrid model creation device 10 is described as determining the judgment threshold using a confusion matrix, but the judgment threshold may be determined with the following two steps using the confusion matrix tables illustrated in FIG. 23A and FIG. 23B.

FIG. 23A and FIG. 23B each illustrate one example of a confusion matrix table according to another embodiment.

First, in step 1, judgment threshold determiner 15 obtains the judgments (binary predictions of positive or negative) of the hybrid model selected by hybrid model selector 14 using a validation data set. Judgment threshold determiner 15 creates a table summarized in the confusion matrix illustrated in FIG. 23A, for example, from the combination of the judgments and ground truth values (binary values of positive or negative), with the threshold set at 0.5.

Next, in step 2, the desired accuracy is entered, for example, an overdetection rate of 0.86%, and the above judgments (binary predictions of positive or negative) are sorted into a list of ground truth values (binary values of positive or negative) to create the confusion matrix table illustrated in FIG. 23B. Here, if an overdetection rate of 0.86% is the desired accuracy, the threshold of 0.42 illustrated in FIG. 23B can be selected as the optimal threshold (judgment threshold).

The following embodiments may also be included within the scope of one or more embodiments of the present disclosure.

(3) Some of the elements included in hybrid model creation device 10 described above may be a computer system including a microprocessor, ROM, RAM, a hard disk unit, a display unit, a keyboard, a mouse, etc. The RAM or hard disk unit stores a computer program. The microprocessor fulfils the functions by operating in accordance with the computer program. Here, the computer program is configured of a plurality of pieced together instruction codes indicating instructions to the computer for fulfilling predetermined functions.

(4) Some of the elements included in hybrid model creation device 10 described above may be configured as a single system large scale integration (LSI) circuit. A system LSI is a super multifunctional LSI manufactured by integrating a plurality of units on a single chip, and is specifically a computer system including, for example, a microprocessor, ROM, and RAM. A computer program is stored in the RAM. The system LSI circuit fulfills the functions as a result of the microprocessor operating according to the computer program.

(5) Some of the elements included in hybrid model creation device 10 described above may be configured as an IC card or standalone module attachable to and detachable from each device. The IC card or module is a computer system including, for example, a microprocessor, ROM, and RAM. The IC card or module may include the above-described super multifunctional LSI. The microprocessor operates according to a computer program to fulfill the functions of the IC card or module. The IC card or module may be tamperproof.

(6) Some of the elements included in hybrid model creation device 10 described above may be a computer-readable recording medium, such as a flexible disk, a hard disk, a CD-ROM, an MO, a DVD, a DVD-ROM, DVD-RAM, a Blu-ray Disc (BD; registered trademark), semiconductor memory, etc, having recording thereon the computer program or the digital signal. Some of the elements included in hybrid model creation device 10 described above may be the digital signal stored on the recording medium.

Some of the elements included in hybrid model creation device 10 described above may transmit the computer program or the digital signal via, for example, a telecommunication line, a wireless or wired communication line, a network such as the Internet, or data broadcasting.

(7) the present disclosure may be the method described above. The present disclosure may be a computer program realizing these methods with a computer, or a digital signal of the computer program.

(8) The present disclosure may be a computer system including a microprocessor and memory, the memory may store the computer program, and the microprocessor may operate according to the computer program.

(9) The present disclosure may be implemented by another independent computer system by recording the program or the digital signal on the recording medium and transporting it, or by transporting the program or the digital signal via the network, etc.

(10) The above embodiments and above variations may be arbitrarily combined.

### INDUSTRIAL APPLICABILITY

The present disclosure is applicable in a method for creating a hybrid model that combines machine learning models for making “non-defective” judgments, etc., in an inspection process, a hybrid model method, a hybrid model creation device, and a program.

1. A hybrid model creation method comprising:
pooling a plurality of models that predict categories of input data, at least one of the plurality of models being a model trained by machine learning;
creating each of a plurality of hybrid model candidates that judge the categories, by selecting and combining two or more models from among the plurality of models pooled; and
selecting one of the plurality of hybrid model candidates as a hybrid model by comparing the plurality of hybrid model candidates.

2. The hybrid model creation method according to claim 1, wherein
the input data is an inspection image of a manufactured product, and
the categories include a category in which the manufactured product is non-defective and a category in which the manufactured product is defective.

3. The hybrid model creation method according to claim 2, wherein
the creating includes:
excluding each output value predicted to be defective due to being higher than a threshold from output values obtained by, for each of the plurality of hybrid model candidates, inputting a validation data set into each of the two or more models selected to compose the hybrid model candidate and causing each of the two or more models to predict the categories of the validation data set; and
creating the plurality of hybrid model candidates by machine learning using the output values excluding each output value higher than the threshold as input and using ground truth values of the validation data set corresponding to the output values used.

4. The hybrid model creation method according to claim 2, wherein
the creating includes:
calculating a convex envelope from a plot of output values predicted to be defective from among output values obtained by, for each of the plurality of hybrid model candidates, inputting a plurality of validation data sets into each of the two or more models selected to compose the hybrid model candidate and causing each of the two or more models to predict the categories of the plurality of validation data sets;
excluding each output value included in the convex envelope from the output values obtained, except vertices of the convex envelope; and
creating the plurality of hybrid model candidates by machine learning using the output values obtained, excluding each output value included in the convex envelope except the vertices of the convex envelope, as input, and using ground truth values of the plurality of validation data sets corresponding to the output values used.

5. The hybrid model creation method according to claim 1, further comprising:
before selecting the two or more models:
obtaining a prediction accuracy of each of the plurality of models pooled by inputting a plurality of validation data sets into each of the plurality of models pooled and causing each of the plurality of models pooled to predict the categories of the plurality of validation sets; and
excluding each model whose prediction accuracy is less than or equal to a threshold from the plurality of models pooled, wherein
the two or more models are selected from the plurality of models remaining after excluding each model whose prediction accuracy is less than or equal to the threshold.

6. The hybrid model creation method according to claim 1, further comprising:
before selecting the two or more models:
obtaining predictions of each of the plurality of models pooled by inputting a plurality of validation data sets into each of the plurality of models pooled and causing each of the plurality of models pooled to predict the categories of the plurality of validation sets;
calculating correlations for all of the plurality of models pooled using the predictions;
excluding each model whose correlation with all other models is stronger than a threshold from the plurality of models pooled, wherein
the two or more models are selected from the plurality of models after excluding each model whose correlation with all other models is stronger than the threshold.

7. The hybrid model creation method according to claim 1, further comprising:
before creating the plurality of hybrid model candidates:
obtaining predictions of each of a plurality of models pooled or selected, by inputting a plurality of validation data sets into each of the plurality of models pooled or selected and causing each of the plurality of models pooled or selected to predict the categories of the plurality of validation data sets; and
calculating correlations for all of the plurality of models pooled or selected using the predictions, wherein
each of the plurality of hybrid model candidates is created by combining the two or more models selected so as not to include a combination of two models having a stronger correlation than a threshold.

8. The hybrid model creation method according to claim 6, wherein
in a deep learning model, the prediction is an output of an intermediate layer or a final layer of the deep learning model.

9. The hybrid model creation method according to claim 1, wherein
each of the plurality of hybrid model candidates is a machine learning model that:
takes, as input, two or more outputs obtained by inputting a plurality of validation data sets into each of the two or more models selected to compose the hybrid model candidate and causing each of the two or more models to predict the categories of the plurality of validation data sets; and
outputs judgments obtained by judging the categories of the plurality of validation data sets, and
the one of the plurality of hybrid model candidates is selected as the hybrid model by comparing the judgments output by the plurality of hybrid model candidates.

10. The hybrid model creation method according to claim 9, wherein
comparing the plurality of hybrid model candidates includes:
for each of the plurality of hybrid model candidates, calculating an importance of each of the two or more models selected to compose the hybrid model candidate from judgments output by the hybrid model candidate; and
reporting each model whose calculated importance is below a preset threshold.

11. The hybrid model creation method according to claim 9, wherein
comparing the plurality of hybrid model candidates includes, for each of the plurality of hybrid model candidates, calculating an importance of each of the two or more models selected to compose the hybrid model candidate from judgments output by the hybrid model candidate, and
the selecting includes selecting one of the plurality of hybrid model candidates, excluding each hybrid model candidate including a model whose calculated importance is below a preset threshold, as the hybrid model.

12. The hybrid model creation method according to claim 9, further comprising:
obtaining, for each of the plurality of models selected to create the plurality of hybrid model candidates, a processing time required by the model to predict the categories of the validation data set after inputting the validation data set into the model; and
defining, for each of the plurality of models, based on the processing times obtained, a value of the processing time of the model relative to a sum of the processing times of all of the plurality of models as a hardware cost, wherein
the creating includes adding, in each of the plurality of hybrid model candidates, a regularization term to a loss function of the machine learning model of the hybrid model candidate, the loss function taking into account the hardware cost of each of the two or more models selected to compose the hybrid model candidate.

13. The hybrid model creation method according to claim 2, further comprising:
creating, for each of a plurality of models selected for creating the plurality of hybrid model candidates, a FAR table of miss rates obtained using a variable threshold, based on a distribution of output values obtained by inputting, as the input data, data that indicates defective in a validation data set into the model and causing the model to predict the categories of the input data, wherein
comparing the plurality of hybrid model candidates includes:
for each of the two or more models selected to compose each of the plurality of hybrid model candidates, looking up an output value obtained by inputting a data sample included in the validation data set into the model and causing the model to predict the category of the data sample in the FAR table to obtain a first FAR value of the model corresponding to the data sample;
obtaining a second FAR value of the hybrid model candidate corresponding to the two or more models by multiplying the first FAR values obtained for the two or more models; and
comparing the plurality of hybrid model candidates using judgments based on the second FAR values of the plurality of hybrid model candidates as judgments output by the plurality of hybrid model candidates in response to inputting the data sample, wherein the data sample is judged to be non-defective when the second FAR value is lower than a preset threshold.

14. The hybrid model creation method according to claim 13, further comprising:
obtaining predictions of each of the plurality of models selected for creating the plurality of hybrid model candidates by inputting a plurality of validation data sets into the plurality of models and causing the plurality of models to predict the categories of the validation data sets; and
using the predictions, calculating a correlation coefficient for each possible combination of two of the plurality of models selected, wherein
the second FAR value is obtained by multiplying the first FAR values obtained for the two or more models and further multiplying the product by a factor that inversely correlates with the correlation coefficient.

15. A hybrid model creation device comprising:
a model pool that pools a plurality of models that predict categories of input data, at least one of the plurality of models being a model trained by machine learning;
a model selector that selects two or more models from among the plurality of models pooled;
a hybrid model candidate creator that creates each of a plurality of hybrid model candidates that judge the categories by combining the two or more models selected, and compares the plurality of hybrid model candidates; and
a hybrid model selector that selects one of the plurality of hybrid model candidates as a hybrid model.

16. A non-transitory computer-readable recording medium for use in a computer, the recording medium having a computer program recorded thereon for causing the computer to execute:
pooling a plurality of models that predict categories of input data, at least one of the plurality of models being a model trained by machine learning;
creating each of a plurality of hybrid model candidates that judge the categories, by selecting and combining two or more models from among the plurality of models pooled; and
selecting one of the plurality of hybrid model candidates as a hybrid model by comparing the plurality of hybrid model candidates.
